(19) United States
(12) Patent Application Publication
(10) Pub. No.: US 2018/0262774 A1
(43) Pub. Date: Sep. 13, 2018

(54) VIDEO PROCESSING APPARATUS USING ONE OR BOTH OF REFERENCE FRAME RE-ROTATION AND CONTENT-ORIENTED ROTATION SELECTION AND ASSOCIATED VIDEO PROCESSING METHOD

(71) Applicant: MEDIATEK INC., Hsin-Chu (TW)

(72) Inventors: Hung-Chih Lin, Nantou County (TW); Jian-Liang Lin, Yilan County (TW); Shen-Kai Chang, Hsinchu County (TW)

(21) Appl. No.: 15/911,185

(22) Filed: Mar. 5, 2018

Related U.S. Application Data
(60) Provisional application No. 62/469,041, filed on Mar. 9, 2017.

(51) Int. Cl. H04N 19/597; G06T 3/60; H04N 19/172

(52) U.S. Cl. CPC H04N 19/597; G06T 2200/04; H04N 19/172; G06T 3/60

(57) ABSTRACT

A video processing method includes: receiving a first input frame with a 360-degree Virtual Reality (360 VR) projection format; applying first content-oriented rotation to the first input frame to generate a first content-rotated frame; encoding the first content-rotated frame to generate a first part of a bitstream, including generating a first reconstructed frame and storing a reference frame derived from the first reconstructed frame; receiving a second input frame with the 360 VR projection format; applying second content-oriented rotation to the second input frame to generate a second content-rotated frame; configuring content re-rotation according to the first content-oriented rotation and the second content-oriented rotation; applying the content re-rotation to the reference frame to generate a re-rotated reference frame; and encoding, by a video encoder, the second content-rotated frame to generate a second part of the bitstream, including using the re-rotated reference frame for predictive coding of the second content-rotated frame.

### CROSS REFERENCE TO RELATED APPLICATIONS

This application claims the benefit of U.S. provisional application No. 62/469,041, filed on Mar. 9, 2017 and incorporated herein by reference.

### BACKGROUND

The present invention relates to 360-degree image/video content processing, and more particularly, to a video processing apparatus using one or both of reference frame re-rotation and content-oriented rotation selection and associated video processing method.

Virtual reality (VR) with head-mounted displays (HMDs) is associated with a variety of applications. The ability to show wide field of view content to a user can be used to provide immersive visual experiences. A real-world environment has to be captured in all directions resulting in an omnidirectional image/video content corresponding to a sphere. With advances in camera rigs and HMDs, the delivery of VR content may soon become the bottleneck due to the high bitrate required for representing such a 360-degree image/video content. When the resolution of the omnidirectional video is 4K or higher, data compression/encoding is critical to bitrate reduction.

In general, the omnidirectional video corresponding to a sphere is transformed into a sequence of images, each of which is represented by a 360-degree Virtual Reality (360 VR) projection format, and then the resulting image sequence is encoded into a bitstream for transmission. However, the original 360-degree image/video content represented in the 360 VR projection format may have poor compression efficiency due to moving objects split and/or stretched by the employed 360 VR projection format. Thus, there is a need for an innovative design which is capable of improving compression efficiency of a 360-degree image/video content represented in a 360 VR projection format.

### SUMMARY

One of the objectives of the claimed invention is to provide a video processing apparatus using one or both of reference frame re-rotation and content-oriented rotation selection and associated video processing method.

According to a first aspect of the present invention, an exemplary video processing method is disclosed. The exemplary video processing method includes: receiving a first input frame having a first 360-degree content represented in a 360-degree Virtual Reality (360 VR) projection format; applying first content-oriented rotation to the first 360-degree content in the first input frame to generate a first content-rotated frame having a first rotated 360-degree content represented in the 360 VR projection format; encoding the first content-rotated frame to generate a first part of a bitstream, comprising generating a first reconstructed frame of the first content-rotated frame and storing a reference frame that is derived from the first reconstructed frame; receiving a second input frame having a second 360-degree content represented in the 360 VR projection format; applying second content-oriented rotation to the 360-degree content in the second input frame to generate a second content-rotated frame having a second rotated 360-degree content represented in the 360 VR projection layout, wherein the second content-oriented rotation is different from the first content-oriented rotation; configuring content re-rotation according to the first content-oriented rotation and the second content-oriented rotation; applying the content re-rotation to a 360-degree content in the reference frame to generate a re-rotated reference frame having a re-rotated 360-degree content represented in the 360 VR projection format; and encoding, by a video encoder, the second content-rotated frame to generate a second part of the bitstream, comprising using the re-rotated reference frame for predictive coding of the second content-rotated frame.

According to a second aspect of the present invention, an exemplary video processing method is disclosed. The exemplary video processing method includes: receiving a bitstream; processing the bitstream to obtain syntax elements from the bitstream, wherein rotation information of a first content-oriented rotation associated with a first decoded frame and a second content-oriented rotation associated with a second decoded frame is indicated by the syntax elements, and the first content-oriented rotation is different from the second content-oriented rotation; decoding a first part of the bitstream to generate the first decoded frame, comprising storing a reference frame that is derived from the first decoded frame, wherein the first decoded frame has a first rotated 360-degree content represented in a 360-degree Virtual Reality (360 VR) projection format, and the first content-oriented rotation is involved in generating the first rotated 360-degree content at an encoder side; and decoding, by a video decoder, a second part of the bitstream to generate the second decoded frame, comprising configuring content re-rotation according to the first content-oriented rotation and the second content-oriented rotation, applying the content re-rotation to a 360-degree content in the reference frame to generate a re-rotated reference frame having a re-rotated 360-degree content represented in the 360 VR projection format, and using, by a video decoder, the re-rotated reference frame for predictive decoding involved in generating the second decoded frame, wherein the second decoded frame has a second rotated 360-degree content represented in the 360 VR projection format, and the second content-oriented rotation is involved in generating the second rotated 360-degree content at the encoder side.

According to a third aspect of the present invention, an exemplary video processing method is disclosed. The exemplary video processing method includes: receiving an input frame having a 360-degree content represented in an equirectangular projection (ERP) format, wherein the input frame is obtained from an omnidirectional content of a sphere via equirectangular projection, the input frame comprises a first partial input frame arranged in a top part of the ERP format, a second partial input frame arranged in a middle part of the ERP format, and a third partial input frame arranged in a bottom part of the ERP format, the first partial input frame corresponds to a north polar region (a region near the north pole) of the sphere, the third partial input frame corresponds to a south polar region (a region near the south pole) of the sphere, and the second partial input frame corresponds to a non-polar region between the north polar region and the south polar region; obtaining a motion amount of the first partial input frame and the third partial input frame; obtaining a motion amount of a selected image region pair of a first image region and a second image region in the input frame, wherein the first image region corresponds to a first area on the sphere, the second image region corresponds to a second area on the sphere, and the first area and the second area include points on a same central axis which passes through the center of the sphere; configuring content-oriented rotation according to the motion amount of the first partial input frame and the third partial input frame and the motion amount of the selected image region pair, composed of the first image region and the second image region; applying the content-oriented rotation to the 360-degree input frame represented in the ERP format to generate a content-rotated frame having a rotated 360-degree content represented in the ERP format, wherein the content-rotated frame comprises a first partial content-rotated frame arranged in the top part of the ERP format, a second partial content-rotated frame arranged in the middle part of the ERP format, and a third partial content-rotated frame arranged in the bottom part of the ERP format, the first partial content-rotated frame includes pixels derived from the first image region, and the third partial content-rotated frame includes pixels derived from the second image region; and encoding, by a video encoder, the content-rotated frame to generate a part of a bitstream.

Further, the associated video processing apparatuses arranged to perform the above video processing methods are also provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 360-degree Virtual Reality (360 VR) system according to an embodiment of the present invention.

FIG. 2 is a diagram illustrating a concept of the proposed content-oriented rotation applied to an input frame according to an embodiment of the present invention.

FIG. 3 is a diagram illustrating a video encoder according to an embodiment of the present invention.

FIG. 4 is a diagram illustrating a video decoder according to an embodiment of the present invention.

FIG. 5 is a diagram illustrating a prediction structure without the proposed reference frame re-rotation according to an embodiment of the present invention.

FIG. 6 is a diagram illustrating a prediction structure with the proposed reference frame re-rotation according to an embodiment of the present invention.

FIG. 7 is a diagram illustrating a sphere with each point specified by its longitude (05) and latitude (8) according to an embodiment of the present invention.

FIG. 8 is a diagram illustrating an input frame with a typical projection layout of a 360-degree content arranged in an ERP format according to an embodiment of the present invention.

FIG. 9 is a diagram illustrating a concept of the proposed content-oriented rotation applied to an input frame with an ERP format according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

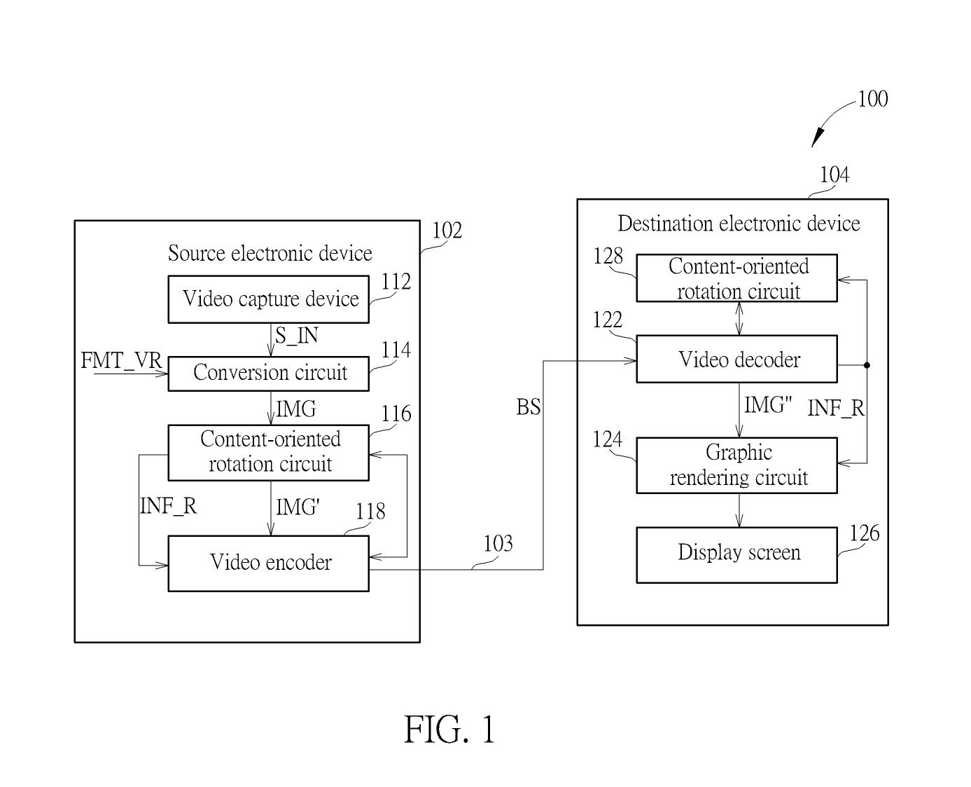

FIG. 1 is a diagram illustrating a 360-degree Virtual Reality (360 VR) system according to an embodiment of the present invention. The 360 VR system 100 includes a source electronic device 102 and a destination electronic device 104. The source electronic device 102 includes a video capture device 112, a conversion circuit 114, a content-oriented rotation circuit 116, and a video encoder 118. For example, the video capture device 112 may be a set of cameras used to provide an omnidirectional content (e.g., multiple images that cover the whole surroundings) S_IN corresponding to a sphere. The conversion circuit 114 generates an input frame IMG with a 360-degree Virtual Reality (360 VR) projection format FMT_VR according to the omnidirectional content S_IN. In this example, the conversion circuit 114 generates one input frame for each video frame of the 360-degree video provided from the video capture device 112. The 360 VR projection format FMT_VR employed by the conversion circuit 114 may be any of available projection formats, including but not limited to an equirectangular projection (ERP) layout, a cubemap projection (CMP) layout, an octahedron projection (OHP) layout, an icosahedron projection (ISP) layout, etc. The content-oriented rotation circuit 116 receives the input frame IMG (which has a 360-degree content, such as a 360-degree image content or a 360-degree video content, represented in the 360 VR projection format FMT_VR), and applies content-oriented rotation to the 360-degree content in the input frame IMG to generate a content-rotated frame IMG′ having a rotated 360-degree content, such as a rotated 360-degree image content or a rotated 360-degree video content, represented in the same 360 VR projection format FMT_VR. In addition, the rotation information INF_R of the applied content-oriented rotation is provided to the video encoder 118 for syntax element signaling.

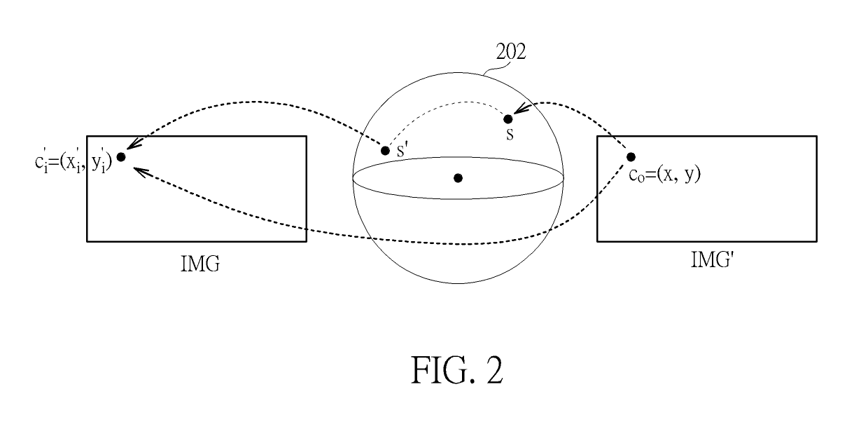

FIG. 2 is a diagram illustrating a concept of the proposed content-oriented rotation applied to the input frame IMG according to an embodiment of the present invention. For clarity and simplicity, it is assumed that the 360 VR projection format FMT_VR is an ERP format. Hence, a 360-degree content of a sphere 202 is mapped onto a rectangular projection face via an equirectangular projection of the sphere 202. In this way, the input frame IMG having the 360-degree content represented in the ERP format is generated from the conversion circuit 114. As mentioned above, an original 360-degree content represented in a 360 VR projection format may have poor compression efficiency due to moving objects split and/or stretched by the employed 360 VR projection format. To address this issue, the present invention proposes applying content-oriented rotation to the 360-degree content of the input frame IMG for coding efficiency improvement.

An example for calculating a pixel value at a pixel position in the content-rotated frame IMG′ is shown in FIG. 2. For a pixel position cₒ with a coordinate (x, y) in the content-rotated frame IMG′, the 2D coordinate (x, y) can be mapped into a 3D coordinate s (a point on the sphere 202) though 2D-to-3D mapping process. Then, this 3D coordinate s is transformed to another 3D coordinate s′ (a point on the sphere 202) after the content-oriented rotation is performed. The content-oriented rotation can be achieved by a rotation matrix multiplication on the 3D coordinate s. Finally, the corresponding 2D coordinate cᵢ′ with a coordinate (x′ᵢ, y′ᵢ) can be obtained in the input frame IMG though 3D-to-2D mapping process. Therefore, for each integer pixel (e.g., cₒ=(x, y)) in the content-rotated frame IMG′, its corresponding position (e.g., cᵢ′=(x′ᵢ, y′ᵢ)) in the input frame IMG can be found though 2D-to-3D mapping from the content-rotated frame IMG′ to the sphere 202, a 3D coordinate transformation on the sphere 202 for content rotation, and 3D-to-2D mapping from the sphere 202 to the input frame IMG. If one or both of x′_{I} and y′ᵢ are non-integer positions, an interpolation filter (not shown) of the content-oriented rotation circuit 116 may be applied to integer pixels around the point cᵢ′=(x′ᵢ, y′ᵢ) in the input frame IMG to derive the pixel value of cₒ=(x, y) in the content-rotated frame IMG′. In this way, the rotated 360-degree content of the content-rotated frame IMG′ can be determined by content-oriented rotation of the original 360-degree content in the input frame IMG.

In contrast to a conventional video encoder that encodes the input frame IMG into a part of bitstream for transmission, the video encoder 118 encodes the content-rotated frame IMG′ into a part of a bitstream BS, and then outputs the bitstream BS to the destination electronic device 104 via a transmission means 103 (e.g., a wired/wireless communication link or a storage medium). In some embodiments of the present invention, the video encoder 118 generates one encoded frame for each content-rotated frame output from the content-oriented rotation circuit 116. Hence, consecutive encoded frames are generated from the video encoder 118, sequentially. In addition, the rotation information INF_R of the content-oriented rotation performed at the content-oriented rotation circuit 116 is provided to the video encoder 118. Hence, the video encoder 118 further signals syntax element(s) via the bitstream BS, wherein the syntax element(s) are set to indicate the rotation information INF_R of the content-oriented rotation applied to each input frame IMG.

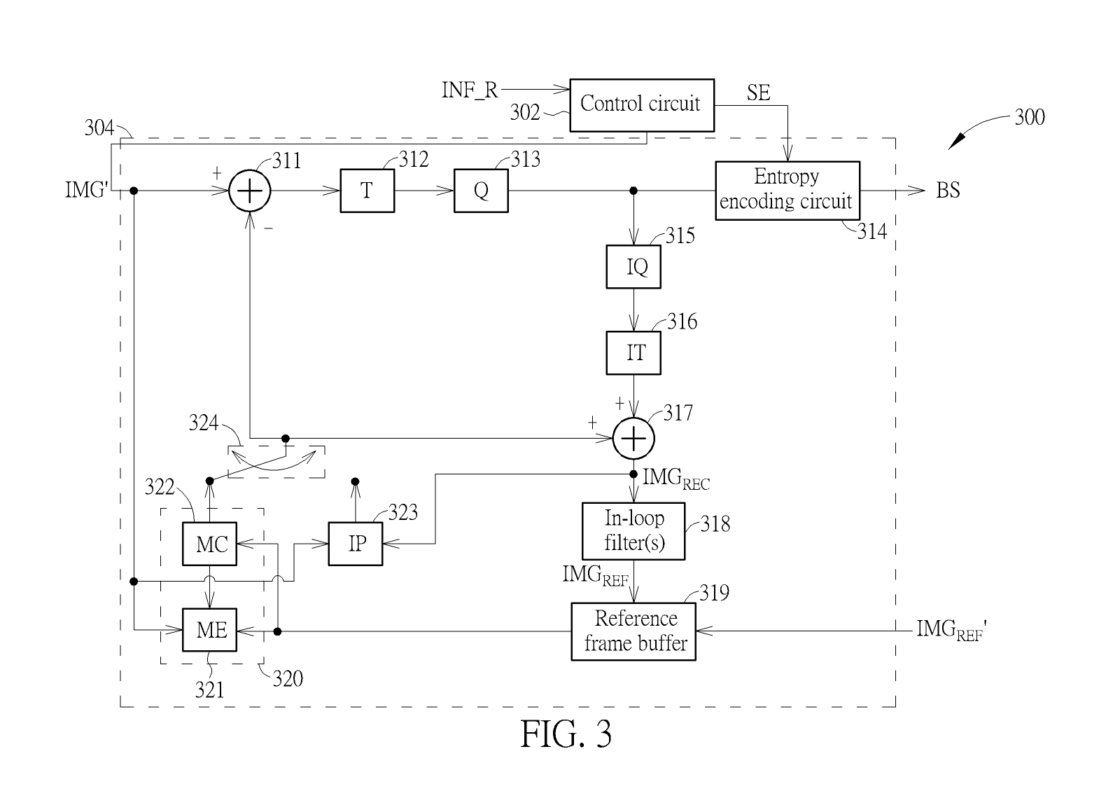

FIG. 3 is a diagram illustrating a video encoder according to an embodiment of the present invention. The video encoder 118 shown in FIG. 1 may be implemented using the video encoder 300 shown in FIG. 3. Hence, the terms “video encoder 118” and “video encoder 300” may be interchangeable hereinafter. The video encoder 300 is a hardware circuit used to compress a raw video data to generate a compressed video data. As shown in FIG. 3, the video encoder 300 includes a control circuit 302 and an encoding circuit 304. It should be noted that the video encoder architecture shown in FIG. 3 is for illustrative purposes only, and is not meant to be a limitation of the present invention. For example, the architecture of the encoding circuit 304 may vary depending upon the coding standard. The encoding circuit 304 encodes the content-rotated frame IMG′ (which has the rotated 360-degree content represented by the 360 VR projection format FMT_VR) to generate a part of the bitstream BS.

As shown in FIG. 3, the encoding circuit 304 includes a residual calculation circuit 311, a transform circuit (denoted by “T”) 312, a quantization circuit (denoted by “Q”) 313, an entropy encoding circuit (e.g., a variable length encoder) 314, an inverse quantization circuit (denoted by “IQ”) 315, an inverse transform circuit (denoted by “IT”) 316, a reconstruction circuit 317, at least one in-loop filter (e.g., de-blocking filter) 318, a reference frame buffer 319, an inter prediction circuit 320 (which includes a motion estimation circuit (denoted by “ME”) 321 and a motion compensation circuit (denoted by “MC”) 322), an intra prediction circuit (denoted by “IP”) 323, and an intra/inter mode selection switch 324. A reconstructed frame IMG_{REC} of the content-oriented frame IMG′ is generated at the reconstruction circuit 317. The in-loop filter (s) 318 applies in-loop filtering (e.g., de-blocking filtering) to the reconstructed frame IMG_{REC} to generate a reference frame IMG_{REF}, and stores the reference frame IMG_{REF} into the reference frame buffer 319. The reference frame IMG_{REF} derived from the reconstructed frame IMG_{REC} may be used by the inter prediction circuit 320 for predictive coding of following content-rotated frame(s). Since basic functions and operations of these circuit components implemented in the encoding circuit 304 are well known to those skilled in the pertinent art, further description is omitted here for brevity.

The major difference between the video encoder 300 and a typical video encoder is that a re-rotated reference frame IMG_{REF}′ may be used for predictive coding of following content-rotated frame(s). For example, the content-oriented rotation circuit 116 may be re-used for encoder-side reference frame re-rotation. The content-oriented rotation circuit 116 configures content re-rotation, applies the content re-rotation to a 360-degree content in the reference frame IMG_{REF} (which has the same content rotation as that of the content-rotated frame IMG′ from which the reference frame IMG_{REF} is generated) to generate a re-rotated reference frame IMG_{REF}′ having a re-rotated 360-degree content represented in the same 360 VR projection format FMT_VR, and stores the re-rotated reference frame IMG_{REF}′ into the reference frame buffer 319. Due to the applied content re-rotation, the re-rotated reference frame IMG_{REF}′ has content rotation different from that of the content-rotated frame IMG′ from which the reference frame IMG_{REF} is generated. When the content rotation involved in generating the current content-rotated frame IMG′ is different from the content rotation involved in generating the next content-rotated frame IMG′, the re-rotated reference frame IMG_{REF}′ may be used by the inter prediction circuit 320 for predictive coding of the next content-rotated frame. Further details of the proposed reference frame re-rotation are described later.

The control circuit 302 is used to receive the rotation information INF_R from a preceding circuit (e.g., content-oriented rotation circuit 116 shown in FIG. 1) and set at least one syntax element (SE) according to the rotation information INF_R, wherein the syntax element (s) indicating the rotation information INF_R will be signaled to a video decoder via the bitstream BS generated from the entropy encoding circuit 314. In this way, the destination electronic device 104 (which has a video decoder) can know details of the encoder-side content-oriented rotation according to the signaled syntax element(s), and can, for example, perform a decoder-side inverse content-oriented rotation to obtain the needed video data for rendering and displaying.

Please refer to FIG. 1 again. The destination electronic device 104 may be a head-mounted display (HMD) device. As shown in FIG. 1, the destination electronic device 104 includes a video decoder 122, a graphic rendering circuit 124, a display screen 126, and a content-oriented rotation circuit 128. The video decoder 122 receives the bitstream BS from the transmission means 103 (e.g., a wired/wireless communication link or a storage medium), and decodes a part of the received bitstream BS to generate a decoded frame IMG″. Specifically, the video decoder 122 generates one decoded frame for each encoded frame delivered by the transmission means 103. Hence, consecutive decoded frames are generated from the video decoder 122, sequentially. In this embodiment, the content-rotated frame IMG′ to be encoded by the video encoder 118 has a 360 VR projection format FMT_VR. Hence, after the bitstream BS is decoded by the video decoder 122, the decoded frame IMG″ has the same 360 VR projection format FMT_VR.

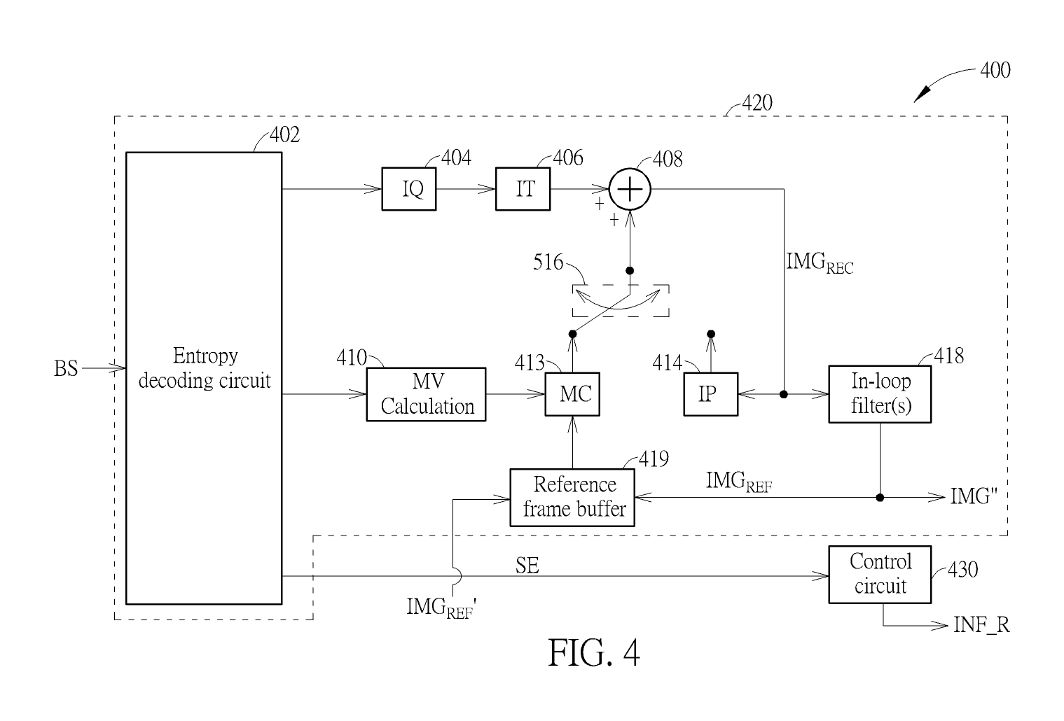

FIG. 4 is a diagram illustrating a video decoder according to an embodiment of the present invention. The video decoder 122 shown in FIG. 1 may be implemented using the video decoder 400 shown in FIG. 4. Hence, the terms “video decoder 122” and “video encoder 400” may be interchangeable hereinafter. The video decoder 400 may communicate with a video encoder (e.g., video encoder 118 shown in FIG. 1) via a transmission means such as a wired/wireless communication link or a storage medium. The video decoder 400 is a hardware circuit used to decompress a compressed image/video data to generate a decompressed image/video data. In this embodiment, the video decoder 400 receives the bitstream BS, and decodes a part of the received bitstream BS to generate a decoded frame IMG″. As shown in FIG. 4, the video decoder 400 includes a decoding circuit 420 and a control circuit 430. It should be noted that the video decoder architecture shown in FIG. 4 is for illustrative purposes only, and is not meant to be a limitation of the present invention. For example, the architecture of the decoding circuit 420 may vary depending upon the coding standard. The decoding circuit 420 includes an entropy decoding circuit (e.g., a variable length decoder) 402, an inverse quantization circuit (denoted by “IQ”) 404, an inverse transform circuit (denoted by “IT”) 406, a reconstruction circuit 408, a motion vector calculation circuit (denoted by “MV Calculation”) 410, a motion compensation circuit (denoted by “MC”) 413, an intra prediction circuit (denoted by “IP”) 414, an intra/inter mode selection switch 416, at least one in-loop filter 418, and a reference frame buffer 419. A reconstructed frame IMG_{REC} is generated at the reconstruction circuit 408. The in-loop filter(s) 418 applies in-loop filtering to the reconstructed frame IMG_{REC} to generate the decoded frame IMG″ which also serves as a reference frame IMG_{REF}, and stores the reference frame IMG_{REF} into the reference frame buffer 419. The reference frame IMG_{REF} derived from the reconstructed frame IMG_{REC} may be used by the motion compensation circuit 413 for predictive decoding involved in generating a next decoded frame. Since basic functions and operations of these circuit components implemented in the decoding circuit 420 are well known to those skilled in the pertinent art, further description is omitted here for brevity.

The major difference between the video decoder 400 and a typical video decoder is that a re-rotated reference frame IMG_{REF}′ may be used by predictive decoding for generating following decoded frame(s). For example, the content-oriented rotation circuit 128 may serve as a re-rotation circuit for decoder-side reference frame re-rotation. The content-oriented rotation circuit 128 configures content re-rotation, applies the configured content re-rotation to a 360-degree content in the reference frame IMG_{REF} (which has the same content rotation as that of the corresponding content-rotated frame IMG′ at the encoder side) to generate a re-rotated reference frame IMG_{REF}^{′} having a re-rotated 360-degree content represented in the same 360 VR projection format FMT_VR, and stores the re-rotated reference frame IMG_{REF}′ into the reference frame buffer 419. When the content rotation involved in generating the current content-rotated frame IMG′ (where the rotation information INF_R is obtained by decoding the corresponding syntax element (s) encoded at the video encoder 118 and transmitted via the bitstream BS) is different from the content rotation involved in generating the next content-rotated frame IMG′ (where the rotation information INF_R is obtained by decoding the corresponding syntax element(s) encoded at the video encoder 118 and transmitted via the bitstream BS), the re-rotated reference frame IMG_{REF}′ may be used by the motion compensation circuit 413 for predictive decoding involved in generating the next decoded frame. Further details of the proposed reference frame re-rotation are described later.

The entropy decoding circuit 402 is further used to perform data processing (e.g., syntax parsing) upon the bitstream BS to obtain syntax element(s) SE signaled by the bitstream BS, and output the obtained syntax element(s) SE to the control circuit 430. Hence, regarding the current decoded frame IMG″ that is a decoded version of the content-rotated frame IMG′, the control circuit 430 can refer to the syntax element(s) SE to determine the rotation information INF_R of the encoder-side content-oriented rotation applied to the input frame IMG.

The graphic rendering circuit 124 renders and displays an output image data on the display screen 126 according to the current decoded frame IMG″ and the rotation information INF_R of content-oriented rotation involved in generating the rotated 360-degree image/video content. For example, according to the rotation information INF_R derived from the signaled syntax element (s) SE, the rotated 360-degree image/video content represented in the 360 VR projection format may be inversely rotated, and the inversely rotated 360-degree image/video content represented in the 360 VR projection format may be used for rendering and displaying.

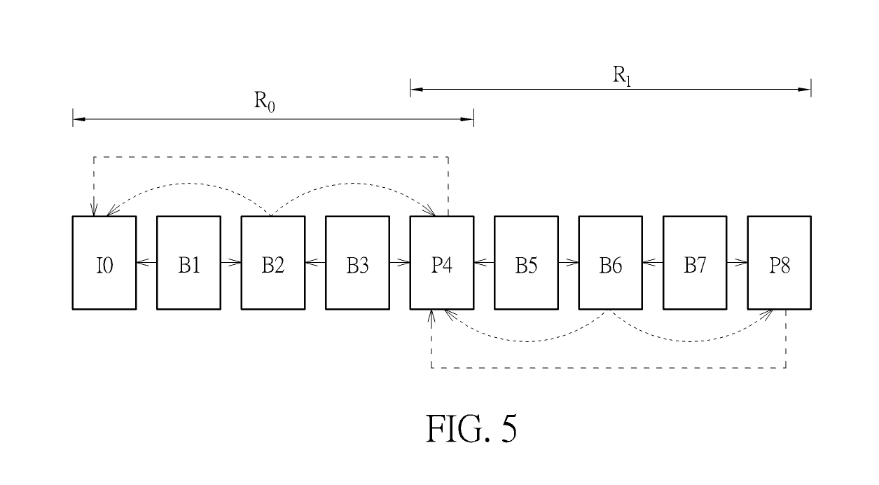

For each input frame IMG of a video sequence to be encoded, the content-oriented rotation circuit 116 of the source electronic device 102 applies proper content rotation to the 360-degree content in the input image IMG, such that the resulting content-rotated frame IMG′ can be encoded with better coding efficiency. For example, the same content rotation may be applied to multiple consecutive frames. FIG. 5 is a diagram illustrating a prediction structure without the proposed reference frame re-rotation according to an embodiment of the present invention. In this example, the video sequence includes one intra frame (labeled by ‘I0’), six bi-predictive frames (labeled by ‘B1’, ‘B2’, ‘B3’, ‘B5’, ‘B6’ and ‘B7’), and two predicted frames (labeled by ‘P4’ and ‘P8’). For example, the intra frame I0, the bi-predictive frames B1-B3 and the predicted frame P4 belong to a first group that uses a first content rotation, and the predicted frame P8 and the bi-predictive frames B5-B7 belong to a second group that uses a second content rotation that is different from the first content rotation. The content-oriented rotation circuit 116 determines content rotation R₀ for the first group, and applies the same content rotation R₀ to each frame included in the first group. In addition, the content-oriented rotation circuit 116 determines content rotation R₁ (R₁≠R₀) for the second group, and applies the same content rotation R₁ to each frame included in the second group.

As shown in FIG. 5, a reference frame derived from a reconstructed frame of the predicted frame P4 is used by predictive coding of the bi-predictive frames B2, B3, B5, B6 and the predicted frame P8. Since the content rotation R₀ is different from the content rotation R₁, using the reference frame derived from the reconstructed frame of the predicted frame P4 whose 360-degree content is rotated by the content rotation R₀ may cause inefficient predictive coding of the bi-predictive frames B5 and B6 and the predicted frame P8, each of which has 360-degree content rotated by the content rotation R₁. To mitigate or avoid the coding efficiency degradation resulting from the discrepancy between content rotation R₁ applied to a current frame to be encoded and the content rotation R₀ possessed by a reference frame used by predictive coding of the current frame, the present invention proposes a reference frame re-rotation scheme.

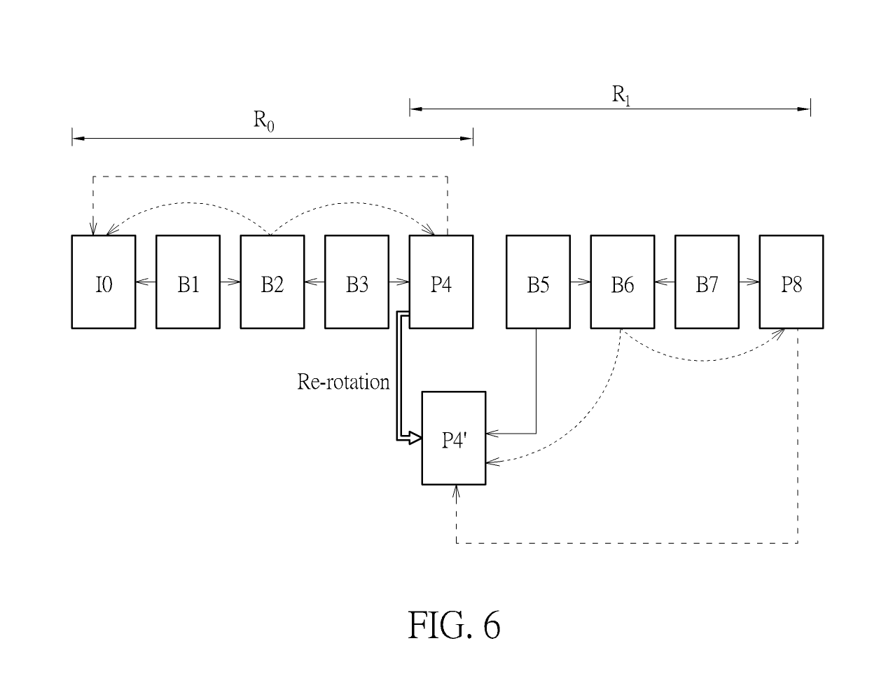

FIG. 6 is a diagram illustrating a prediction structure with the proposed reference frame re-rotation according to an embodiment of the present invention. The content-oriented rotation circuit 116 receives a first input frame (e.g., predicted frame P4) having a first 360-degree content represented in a 360 VR projection format FMT_VR, and applies first content-oriented rotation (e.g., R₀) to the first 360-degree content in the first input frame to generate a first content-rotated frame having a first rotated 360-degree content represented in the 360 VR projection format FMT_VR. The video encoder 118 encodes the first content-rotated frame to generate a first part of the bitstream BS, wherein a first reconstructed frame of the first content-rotated frame is generated, and a reference frame that is derived from the first reconstructed frame is stored into a reference frame buffer (e.g., reference frame buffer 319 shown in FIG. 3).

Due to the prediction structure in FIG. 6, the video encoder 118 does not start encoding the input frames following the predictive frame P4 (the bi-predictive frames ‘B5’, ‘B6’ and ‘B7’, and the predictive frame ‘P8’) until the predictive frame P8 is received. In this example, these frames are applied by a second content-oriented rotation (e.g., R₁) to the 360-degree content. Moreover, the encoding order of these frames is P8→B6→B5→B7.

Hence, the content-oriented rotation circuit 116 receives a second input frame (e.g., predictive frame P8) having a second 360-degree content represented in the 360 VR projection format FMT_VR, and applies second content-oriented rotation (e.g., R₁) to the 360-degree content in the second input frame to generate a second content-rotated frame having a second rotated 360-degree content represented in the 360 VR projection format FMT_VR. Since the second content-oriented rotation is different from the first content-oriented rotation (e.g., R₀≠R₁), the content-oriented rotation circuit 116 further configures content re-rotation according to the first content-oriented rotation and the second content-oriented rotation, applies the content re-rotation to a 360-degree content in the reference frame (which is derived from the reconstructed frame of the first input frame (e.g., predicted frame P4)) to generate a re-rotated reference frame (e.g., P4′) having a re-rotated 360-degree content represented in the 360 VR projection format FMT_VR, and stores the re-rotated reference frame into the reference frame buffer (e.g., reference frame buffer 319 shown in FIG. 3). For example, the content re-rotation may be set by R₁R₀⁻¹, where R₀ represents the first content-oriented rotation, R₁ represents the second content-oriented rotation, and R₀⁻¹ represents derotation of the first content-oriented rotation.

Like content rotation illustrated in FIG. 2, content re-rotation can be used by the encoder side to obtain a re-rotated reference frame from a reference frame. Assume that the frame IMG′ shown in FIG. 2 is a re-rotated reference frame and the frame IMG shown in FIG. 2 is a reference frame. Regarding a pixel position cₒ with a coordinate (x, y) in the re-rotated reference frame IMG′, the 2D coordinate (x, y) can be mapped into a 3D coordinate s (a point on the sphere 202) though 2D-to-3D mapping process. Then, this 3D coordinate s is transformed to another 3D coordinate s′ (a point on the sphere 202) after the content re-rotation R₁R₀⁻¹ is performed. The content re-rotation R₁R₀¹ can be achieved by a rotation matrix multiplication. Finally, its corresponding 2D coordinate with a coordinate (x′ᵢ, y′ᵢ) can be obtained in the reference frame IMG though 3D-to-2D mapping process. Therefore, for each integer pixel (e.g., cₒ=(x, y)) in the re-rotated reference frame IMG′, the corresponding position (e.g., cᵢ′=(x′ᵢ, y′ᵢ)) in the reference frame IMG can be found though 2D-to-3D mapping from the re-rotated reference frame IMG′ to the sphere 202, a 3D coordinate transformation on the sphere 202 for content re-rotation, and 3D-to-2D mapping from the sphere 202 to the reference frame IMG. If one or both of x′_{I} and y′ᵢ are non-integer positions, an interpolation filter (not shown) of the content-oriented rotation circuit 116 may be applied to integer pixels around the point cᵢ′=(x′ᵢ, y′ᵢ) in the reference frame IMG to derive the pixel value of cₒ=(x, y) in the re-rotated reference frame IMG′.

After P4 encoding is done, the video encoder 118 then encodes the second content-rotated frame (e.g., the predictive frame P8) to generate a second part of the bitstream, wherein the re-rotated reference frame (e.g., P4′) is used for predictive coding of the second content-rotated frame. In addition, the same re-rotated reference frame (e.g., P4′) is also used for predictive coding of other content-rotated frames (e.g., bi-predictive frames ‘B5’, ‘B6’ and ‘B7’) generated by applying the second content-oriented rotation.

As mentioned above, the reference frame derived from the first reconstructed frame of the first input frame (e.g., P4) is stored into the reference frame buffer (e.g., reference frame buffer 319 shown in FIG. 3), and the re-rotated reference frame (e.g., P4′) obtained by applying content re-rotation to the reference frame is also stored into the reference frame buffer. In one exemplary decoded picture buffer (DPB) design, an additional storage space in the reference frame buffer is allocated for buffering the re-rotated reference frame, such that the reference frame and the re-rotated reference frame co-exist in the same reference frame buffer (i.e., DPB). In another exemplary DPB design, the reference frame stored in the reference frame buffer is replaced with (i.e., overwritten by) the re-rotated reference frame. Since the storage space allocated for buffering the reference frame is re-used to buffer a re-rotated version of the reference frame, the cost of the reference frame buffer can be saved.

Since the rotation information INF_R of first content-oriented rotation (e.g., R₀) and second content-oriented rotation (e.g., R₁) is signaled via the bitstream BS, the reference frame re-rotation can be also performed at the decoder side to obtain the same re-rotated reference frame used at the encoder side. For example, the video decoder 122 receives the bitstream BS, and processes the bitstream BS to obtain syntax elements from the bitstream BS, wherein rotation information INF_R of first content-oriented rotation (e.g., R₀) associated with a first decoded frame (e.g., predicted frame P4 shown in FIG. 6) and the second content-oriented rotation (e.g., R₁) associated with a second decoded frame (e.g., the predictive frame P8) is indicated by the parsed syntax elements. The video decoder 122 decodes a first part of the bitstream BS to generate the first decoded frame, and also stores a reference frame derived from the first decoded frame into a reference frame buffer (e.g., reference frame buffer 419 shown in FIG. 4), wherein the first decoded frame has a first rotated 360-degree content represented in the 360 VR projection format FMT_VR, and the first content-oriented rotation is involved in generating the first rotated 360-degree content at the encoder side (e.g., source electronic device 102, particularly content-oriented rotation circuit 116).

In a case where the second content-oriented rotation is different from the first content-oriented rotation, the content-oriented rotation circuit 128 configures content re-rotation according to the first content-oriented rotation and the second content-oriented rotation, applies the content re-rotation to a 360-degree content in the reference frame (which is derived from the first decoded frame (e.g., predicted frame P4)) to generate a re-rotated reference frame (e.g., P4′) having a re-rotated 360-degree content represented in the 360 VR projection format FMT_VR, and stores the re-rotated reference frame into the reference frame buffer (e.g., reference frame buffer 419 shown in FIG. 4). For example, the content re-rotation may be achieved by R₁R₀⁻¹, where R₀ represents the first content-oriented rotation, R₁ represents the second content-oriented rotation, and R₀⁻¹ represents derotation of the first content-oriented rotation.

Like content rotation illustrated in FIG. 2, content re-rotation can be used by the decoder side to obtain a re-rotated reference frame from a reference frame. Since a person skilled in the pertinent art can readily understand the principle of the decoder-side reference frame re-rotation after reading above paragraphs directed to the encoder-side reference frame re-rotation, further description is omitted here for brevity.

After decoding the first part of the bitstream BS, the video decoder 122 decodes a second part of the bitstream BS to generate the second decoded frame. The re-rotated reference frame (e.g., P4′) is used for predictive decoding involved in generating the second decoded frame, wherein the second decoded frame has a second rotated 360-degree content represented in the 360 VR projection format FMT_VR, and the second content-oriented rotation is involved in generating the second rotated 360-degree content at the encoder side (e.g., source electronic device 102, particularly content-oriented rotation circuit 116). In addition, the same re-rotated reference frame (e.g., P4′) is used for predictive decoding involved in generating other decoded frames (e.g., bi-predictive frames ‘B5’, ‘B6’ and ‘B7’).

As mentioned above, the reference frame that is derived from the first decoded frame (e.g., P4) is stored into the reference frame buffer (e.g., reference frame buffer 419 shown in FIG. 4), and the re-rotated reference frame (e.g., P4′) obtained by applying content re-rotation to the reference frame is also stored into the reference frame buffer. In one exemplary decoded picture buffer (DPB) design, an additional storage space in the reference frame buffer is allocated for buffering the re-rotated reference frame, such that the reference frame and the re-rotated reference frame co-exist in the same reference frame buffer (i.e., DPB). In another exemplary DPB design, the reference frame stored in the reference frame buffer is replaced with (i.e., overwritten by) the re-rotated reference frame. Since the storage space allocated for buffering the reference frame is re-used to buffer a re-rotated version of the reference frame, the cost of the reference frame buffer can be saved.

It should be noted that the prediction structure and the sequence of intra frame (I-frame), bi-predictive frames (B-frames), and predicted frames (P-frames) as illustrated in FIG. 5 and FIG. 6 are for illustrative purposes only, and are not meant to be limitations of the present invention. For example, the same reference frame re-rotation concept may be applied to a different prediction structure. The same objective of improving the coding efficiency by using a prediction structure with the proposed reference frame re-rotation is achieved.

As mentioned above, an original 360-degree content represented in a 360 VR projection format may have poor compression efficiency due to moving objects split and/or stretched by the employed 360 VR projection format. To address this issue, the present invention proposes applying content-oriented rotation to the 360-degree content for coding efficiency improvement. A proper setting of content-oriented rotation for each input frame to be encoded should be determined by the content-oriented rotation circuit 116 of the source electronic device 102. For example, when the 360 VR projection format FMT_VR is an equirectangular projection (ERP) format, the content-oriented rotation for each input frame to be encoded can be determined according to a proposed content-oriented rotation selection algorithm based on a motion analysis of a 360-degree content of the input frame.

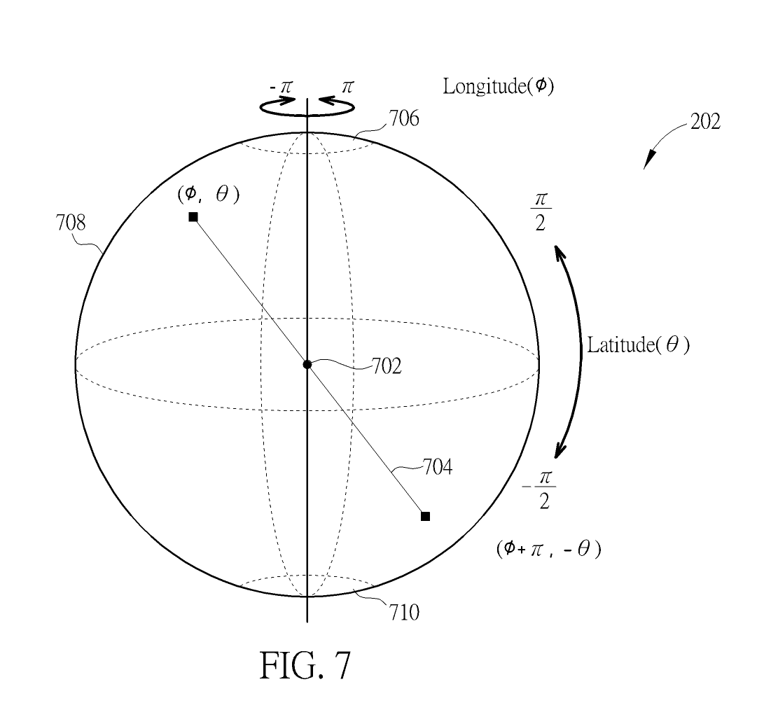

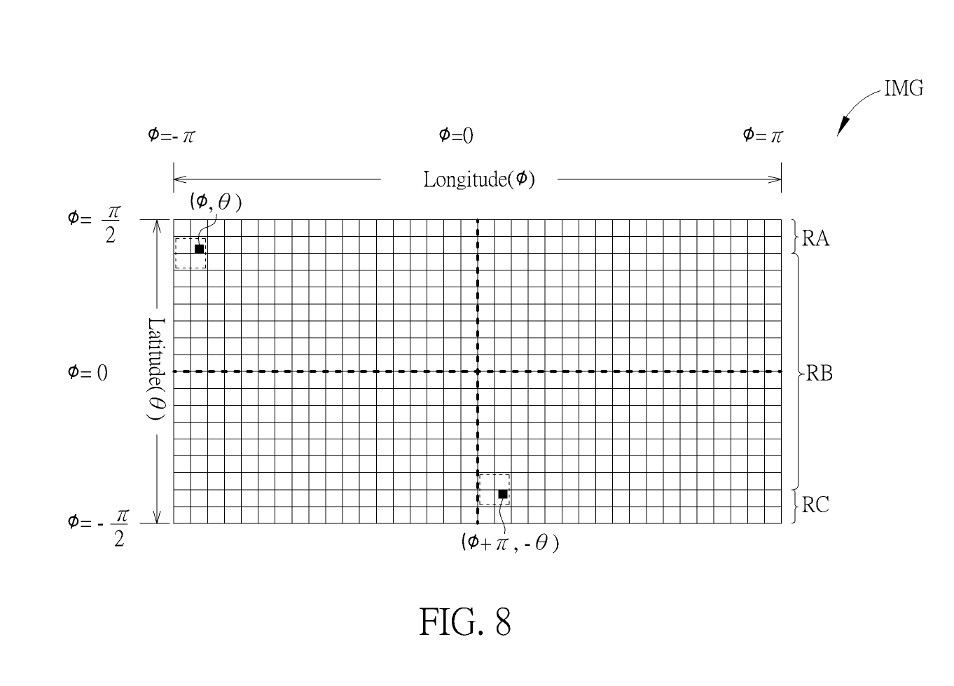

Please refer to FIG. 7 in conjunction with FIG. 8. FIG. 7 illustrates a sphere with each point specified by its longitude (ϕ) and latitude (θ) according to an embodiment of the present invention. In FIG. 8, an input frame with a 360-degree content is arranged in a typical layout of ERP format according to an embodiment of the present invention. As shown in FIG. 7, the sphere 202 includes a north polar region 706 centered at the north pole, a south polar region 710 centered at the south pole, and a non-polar region 708 between the north polar region 706 and the south polar region 710. As shown in FIG. 8, the input frame IMG is obtained from an omnidirectional content of the sphere 202 via a typical layout of ERP format, and has a first partial input frame RA arranged in a top part of the ERP format, a second partial input frame RB arranged in a middle part of the ERP format, and a third partial input frame RC arranged in a bottom part of the ERP format, wherein the first partial input frame RA corresponds to the north polar region 706 of the sphere 202 (i.e., the first partial input frame RA is a rectangular area obtained from the north polar region 706 of the ERP format), the second partial input frame RB corresponds to the non-polar region 708 of the sphere 202 (i.e., the second partial input frame RB is a rectangular area obtained from the non-polar region 708 of the ERP format), and the third partial input frame RC corresponds to the south pole region 710 of the sphere 202 (i.e., the third partial input frame RC is a rectangular area obtained from the south polar region 710 of the ERP format). By way of example, but not limitation, each of the first partial input frame RA and the third partial input frame RC may be the region of successive coding-block rows (e.g., macroblock (MB) rows or largest coding unit (LCU) rows), as shown in FIG. 8.

In accordance with the proposed content-oriented rotation selection algorithm, the content-oriented rotation circuit 116 receives the input frame IMG having the 360-degree content represented in a typical layout of ERP format, as illustrated in FIG. 8, obtains a motion amount Mₚₒₗₑ of the first partial input frame RA and the third partial input frame RC, and obtains a motion amount M_{(ϕ*, θ*)} of a selected image region pair in the input frame IMG, configures content-oriented rotation according to the motion amounts Mₚₒₗₑ and M_{(ϕ*, θ*)}, and applies the content-oriented rotation to the 360-degree content in the input frame IMG to generate a content-rotated frame IMG′ having a rotated 360-degree content represented in the ERP format. After the content-rotated frame IMG′ is generated, the video encoder 118 encodes the content-rotated frame IMG′ to generate a part of the bitstream BS.

Regarding the selected image region pair consisting of a first image region and a second image region, the first image region (e.g., 2×2 LCUs or 4×4 LCUs) corresponds to a first area on the sphere 202, the second image region (e.g., 2×2 LCUs or 4×4 LCUs) corresponds to a second area on the sphere 202, and the first area and the second area include points on the same central axis which passes through a center 702 of the sphere 202. In FIG. 7, for example, the first image region (e.g., 2×2 LCUs or 4×4 LCUs) may correspond to the first area comprising a point (ϕ, θ) (e.g., a central point) on the sphere 202, and the second image region (e.g., 2×2 LCUs or 4×4 LCUs) may correspond to the second area comprising a point (ϕ₊π, −θ) (e.g., a central point) on the sphere 202, wherein the point (ϕ, θ) and the point (ϕ₊π, −θ) are on the same central axis 704 which passes through the center 702 of the sphere 202. In other words, the points (ϕ, θ) and (ϕ₊π, −θ) are symmetric with respect to the center 702 of the sphere 202. Moreover, this first image region and this second image region form an image region pair.

In one exemplary embodiment, the selected image region pair is determined by a pre-defined criterion from different image region pairs in the input frame IMG having the 360-degree content represented in a typical layout of ERP format. For example, the content-oriented rotation circuit 116 obtains a plurality of motion amounts from certain image region pair candidates (e.g., all possible image region pairs can be examined in the input frame). After the motion amounts of the image region pair candidates are collected, the content-oriented rotation circuit 116 compares these motion amounts and then selects the image region pair on the sphere 202 that has a minimum motion amount, wherein the image region pair represents the two image regions comprising the point (ϕ*, θ*) and the point (θ*₊ϕ, −θ*), respectively, and the minimum motion amount is denoted as M_{(ϕ*, θ*)}.

The content-oriented rotation circuit 116 that receives the successive input frames IMG having the 360-degree content represented in a typical layout of ERP format may need two types of motion statistics, including the average motion amount Mₚₒₗₑ in the polar regions 706 and 710 (i.e., RA and RC in FIG. 8), and the minimum motion amount M_{(ϕ*, θ*)} found in the image region pairs in the input frame IMG, consisting of regions 706, 708, and 710 (i.e., RA, RB, and RC in FIG. 8). These two motion statistics, Mₚₒₗₑ and M_{(ϕ*, θ*)}, are evaluated by collecting all motion amounts in the first partial input frame RA, the second partial input frame RB, and the third partial input frame RC. For example, the motion amount can be the magnitude of motion vector.

In one exemplary design, motion vectors needed by motion amount collection may be found by a pre-processing motion estimation (ME) algorithm. To reduce the pre-processing ME algorithm in the content-oriented rotation circuit 116, for example, the input frame is divided into a plurality of 4×4 LCU regions and has equal-sized coding units, each of which has one motion vector with integer precision. Then, the motion amount of a 4×4 LCU region is the accumulation of motion magnitude of its coding units. Therefore, the motion amount Mₚₒₗₑ is the averaged motion amount of all 4×4 LCU regions in the first partial input frame RA and the third partial input frame RC. Similarly, the minimum motion amount M_{(ϕ*, θ*)} is the smallest averaged motion amount of the selected image region pair, which is determined from the image region pair candidates in the input frame. Furthermore, the selected image region pair is composed of a 4×4 LCU image region comprising the point (ϕ*, θ*) and a 4×4 LCU image region comprising the point (ϕ*+π, −θ*). However, this is for illustrative purposes only, and is not meant to be a limitation of the present invention.

The motion magnitude may be represented by Manhattan distance (|x|+|y|) or Euclidean distance (x²+y²), where x and y are the horizontal and vertical components of a motion vector, respectively. However, this is for illustrative purposes only, and is not meant to be a limitation of the present invention.

After the motion amount Mₚₒₗₑ of the first partial input frame RA and the third partial input frame RC and the motion amount M_{(ϕ*, θ*)} of the selected image region pair are obtained, the content-oriented rotation circuit 116 configures content-oriented rotation according to the motion amounts Mₚₒₗₑ and M_{(ϕ*, θ*)}. Due to inherent characteristics of the equirectangular projection, projecting image contents of the north polar region 706 and the south polar region 710 onto the first partial input frame RA (which is arranged in the top part of the ERP format) and the third partial input frame RC (which is arranged in the bottom part of the ERP format) generally results in larger distortion when compared to projecting the image content of the non-polar region 708 onto the second partial input frame RB (which is arranged in the middle part of the ERP format). If the first partial input frame RA and the third partial input frame RC have high-motion contents, the coding efficiency of the first partial input frame RA and the third partial input frame RC would be degraded greatly. Based on such an observation, the present invention proposes improving the coding efficiency by rotating low-motion contents (or zero-motion contents) in the image region pair to the first partial input frame RA (which is arranged in the top part of the ERP format) and the third partial input frame RC (which is arranged in the bottom part of the ERP format). Hence, the content-oriented rotation circuit 116 applies the content-oriented rotation to the 360-degree content in the input frame IMG to generate a content-rotated frame having a rotated 360-degree content represented in the same ERP format, wherein the content-rotated frame has a first partial content-rotated frame arranged in the top part of the ERP format, a second partial content-rotated frame arranged in the middle part of the ERP format, and a third partial content-rotated frame arranged in the bottom part of the ERP format, the first partial content-rotated frame includes pixels derived from the first image region of the selected image region pair, and the third partial content-rotated frame includes pixels derived from the second image region.

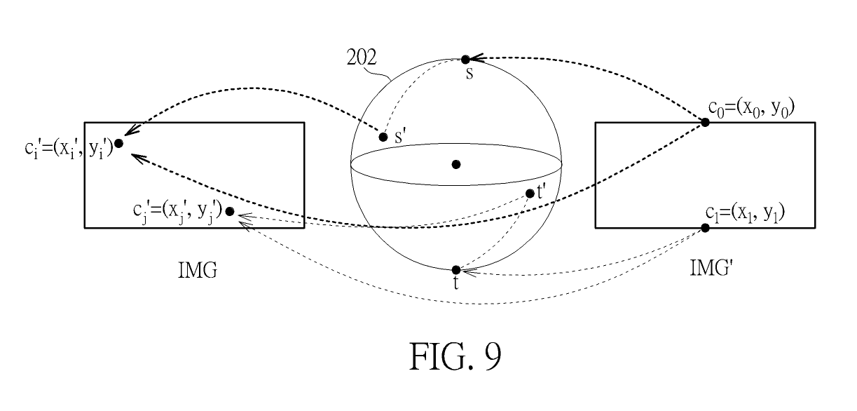

According to an embodiment of the present invention, FIG. 9 illustrates a concept of the proposed content-oriented rotation applied to an input frame with an ERP layout. In this example, the 360 VR projection format FMT_VR is an ERP format. Hence, a 360-degree content of the sphere 202 is mapped onto a rectangular projection face via an equirectangular projection of the sphere 202. In this way, the input frame IMG having the 360-degree content represented in the ERP format is generated from the conversion circuit 114. An original 360-degree content represented in the ERP format may have poor compression efficiency due to high-motion contents included in the high-distortion top part and bottom part of the ERP format. Hence, applying content-oriented rotation to the 360-degree content can improve coding efficiency by rotating low-motion contents (or zero-motion contents) to the high-distortion top part and bottom part of the ERP format and rotating high-motion contents to the low-distortion middle part of the ERP format.

An example for calculating a pixel value at a pixel position in the content-rotated frame IMG′ is shown in FIG. 9. For a pixel position cₒ with a coordinate (x₀, y₀) in the content-rotated frame IMG′, the 2D coordinate (x₀, y₀) can be mapped into a 3D coordinate s (the north pole on the sphere 202) though 2D-to-3D mapping process. Then, this 3D coordinate s is transformed to another 3D coordinate s′ (a point on the sphere 202) after the content-oriented rotation that is determined by the proposed content-oriented rotation algorithm is performed. For example, the point s′ on the sphere 202 may be located at a region comprising the point (ϕ*, θ*) associated with the minimum motion amount M_{(ϕ*, θ&)} found by the content-oriented rotation selection algorithm. The content-oriented rotation can be achieved by a rotation matrix multiplication. Finally, a corresponding 2D coordinate cᵢ′ with a coordinate (x′ᵢ, y′ᵢ) can be found in the input frame IMG though 3D-to-2D mapping process. In addition, for a pixel position c₁ with a coordinate (x₁, y₁) in the content-rotated frame IMG′, the 2D coordinate (x₁, y₁) can be mapped into a 3D coordinate t (the south pole on the sphere 202) though 2D-to-3D mapping process. Then, this 3D coordinate t is transformed to another 3D coordinate t′ (a point on the sphere 202) after the content-oriented rotation that is determined by the proposed content-oriented rotation algorithm is performed. For example, the point Con the sphere 202 is located at a region comprising the point (ϕ*+π, −θ*) associated with the minimum motion amount M_{(ϕ*, θ*)} found by the content-oriented rotation selection algorithm. The content-oriented rotation can be achieved by a rotation matrix multiplication. Finally, a corresponding 2D coordinate cⱼ′ with a coordinate (x′ⱼ, y′ⱼ) can be found in the input frame IMG though 3D-to-2D mapping process. More specifically, for each integer pixel in the content-rotated frame IMG′, the corresponding position in the input frame IMG can be found though 2D-to-3D mapping from the content-rotated frame IMG′ to the sphere 202, a 3D coordinate transformation on the sphere 202 for content rotation, and 3D-to-2D mapping from the sphere 202 to the input frame IMG. If one or both of x′_{I} and y′ᵢ (or x′ⱼ and y′ⱼ) are non-integer positions, an interpolation filter (not shown) of the content-oriented rotation circuit 116 may be applied to integer pixels around the point cᵢ′=(x′ᵢ, y′ᵢ) (or cⱼ′=(x′ⱼ, y′ⱼ)) in the input frame IMG to derive the pixel value of cₒ=(x₀, y₀) (or c₁=(x₁, y₁)) in the content-rotated frame IMG′.

As mentioned above, applying content-oriented rotation to the 360-degree content can improve coding efficiency by rotating low-motion contents (or zero-motion contents) to the high-distortion top part and bottom part of the ERP format and rotating high-motion contents to the low-distortion middle part of the ERP format. If the high-distortion top part and bottom part of the ERP format of the input frame IMG does not have high-motion contents and/or there are no low-motion contents (or zero-motion contents) that can be found in the input frame IMG, the content-oriented rotation may be skipped such that the input frame IMG is bypassed by the content-oriented rotation circuit 116 and directly encoded by the video encoder 118. The content-oriented rotation is allowed to be applied to the input frame IMG with the ERP format when some rotation criteria are satisfied. For example, two pre-defined threshold values may be used to determine whether or not the 360-degree content of the input frame IMG needs to be rotated for coding efficiency improvement. The content-oriented rotation circuit 116 checks the rotation criteria by comparing the motion amount Mₚₒₗₑ of the first partial input frame RA and the third partial input frame RC with a first predetermined threshold value Tₚₒₗₑ, comparing the motion amount M_{(ϕ*, θ*)} of the selected image region pair with a second predetermined threshold value Tₘ, checking if the motion amount Mₚₒₗₑ is larger than the first predetermined threshold value Tₚₒₗₑ, and checking if the motion amount M_{(ϕ*, θ*)} is smaller than the second predetermined threshold value Tₘ. The first predetermined threshold value Tₚₒₗₑ is used to check if the first partial input frame RA and the third partial input frame RC have high-motion contents, and the second predetermined threshold value Tₘ is used to classify if the selected image region pair has low-motion contents (or zero-motion contents).

When checking results indicate that the motion amount Mₚₒₗₑ is not larger than the first predetermined threshold value Tₚₒₗₑ and/or the motion amount M_{(ϕ*, θ*)} is not smaller than the second predetermined threshold value Tₘ, the content-oriented rotation circuit 116 does not apply the content-oriented rotation to the 360-degree content in the input frame IMG.

When checking results indicate that the motion amount Mₚₒₗₑ is larger than the first predetermined threshold value Tₚₒₗₑ and the motion amount M_{(ϕ*, θ*)} is smaller than the second predetermined threshold value Tₘ (i.e., these two criteria, Mₚₒₗₑ>Tₚₒₗₑ and M_{(ϕ*, θ*)}<Tₘ, are satisfied), the content-oriented rotation circuit 116 applies the content-oriented rotation to the 360-degree content in the input frame IMG.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing method comprising:
receiving a first input frame having a first 360-degree content represented in a 360-degree Virtual Reality (360 VR) projection format;
applying first content-oriented rotation to the first 360-degree content in the first input frame to generate a first content-rotated frame having a first rotated 360-degree content represented in the 360 VR projection format;
encoding the first content-rotated frame to generate a first part of a bitstream, comprising:
generating a first reconstructed frame of the first content-rotated frame; and
storing a reference frame that is derived from the first reconstructed frame;
receiving a second input frame having a second 360-degree content represented in the 360 VR projection format;
applying second content-oriented rotation to the 360-degree content in the second input frame to generate a second content-rotated frame having a second rotated 360-degree content represented in the 360 VR projection format, wherein the second content-oriented rotation is different from the first content-oriented rotation;
configuring content re-rotation according to the first content-oriented rotation and the second content-oriented rotation;
applying the content re-rotation to a 360-degree content in the reference frame that is derived from the first reconstructed frame to generate a re-rotated reference frame having a re-rotated 360-degree content represented in the 360 VR projection format; and
encoding, by a video encoder, the second content-rotated frame to generate a second part of the bitstream, comprising:
using the re-rotated reference frame for predictive coding of the second content-rotated frame.

2. The video processing method of claim 1, wherein the content re-rotation is set by R₁R₀⁻¹, where R₀ represents the first content-oriented rotation, R₁ represents the second content-oriented rotation, and R₀⁻¹ represents derotation of the first content-oriented rotation.

3. The video processing method of claim 1, wherein the reference frame and the re-rotated reference frame co-exist in a same reference frame buffer.

4. The video processing method of claim 1, wherein storing the reference frame that is derived from the first reconstructed frame comprises:
storing the reference frame into a reference frame buffer; and applying the content re-rotation to the 360-degree content in the reference frame to generate the re-rotated reference frame further comprises:
replacing the reference frame in the reference frame buffer with the re-rotated reference frame.

5. A video processing method comprising:
receiving a bitstream;
processing the bitstream to obtain syntax elements from the bitstream, wherein rotation information of a first content-oriented rotation associated with a first decoded frame and a second content-oriented rotation associated with a second decoded frame is indicated by the syntax elements, and the first content-oriented rotation is different from the second content-oriented rotation;
decoding a first part of the bitstream to generate the first decoded frame, comprising:
storing a reference frame that is derived from the first decoded frame, wherein the first decoded frame has a first rotated 360-degree content represented in a 360-degree Virtual Reality (360 VR) projection format, and the first content-oriented rotation is involved in generating the first rotated 360-degree content at an encoder side; and
decoding a second part of the bitstream to generate the second decoded frame, comprising:
configuring content re-rotation according to the first content-oriented rotation and the second content-oriented rotation;
applying the content re-rotation to a 360-degree content in the reference frame that is derived from the first decoded frame to generate a re-rotated reference frame having a re-rotated 360-degree content represented in the 360 VR projection format; and
using, by a video decoder, the re-rotated reference frame for predictive decoding involved in generating the second decoded frame, wherein the second decoded frame has a second rotated 360-degree content represented in the 360 VR projection format, and the second content-oriented rotation is involved in generating the second rotated 360-degree content at the encoder side.

6. The video processing method of claim 5, wherein the content re-rotation is set by R₁R₀⁻¹, where R₀ represents the first content-oriented rotation, R₁ represents the second content-oriented rotation, and R₀⁻¹ represents derotation of the first content-oriented rotation.

7. The video processing method of claim 5, wherein the reference frame and the re-rotated reference frame co-exist in a same reference frame buffer.

8. The video processing method of claim 5, wherein storing the reference frame that is derived from the first decoded frame comprises:
storing the reference frame into a reference frame buffer; and
applying the content re-rotation to the 360-degree content in the reference frame to generate the re-rotated reference frame further comprises:
replacing the reference frame in the reference frame buffer with the re-rotated reference frame.

9. A video processing method comprising:
receiving an input frame having a 360-degree content represented in an equirectangular projection (ERP) format, wherein the input frame is obtained from an omnidirectional content of a sphere via equirectangular projection, the input frame comprises a first partial input frame arranged in a top part of the ERP format, a second partial input frame arranged in a middle part of the ERP format, and a third partial input frame arranged in a bottom part of the ERP format, the first partial input frame corresponds to a north polar region of the sphere, the third partial input frame corresponds to a south polar region of the sphere, and the second partial input frame corresponds to a non-polar region between the north polar region and the south polar region;
obtaining a motion amount of the first partial input frame and the third partial input frame;
obtaining a motion amount of a selected image region pair of a first image region and a second image region in the input frame, wherein the first image region corresponds to a first area on the sphere, the second image region corresponds to a second area on the sphere, and the first area and the second area include points on a same central axis which passes through a center of the sphere;
configuring content-oriented rotation according to the motion amount of the first partial input frame and the third partial input frame and the motion amount of the selected image region pair;
applying the content-oriented rotation to the 360-degree content in the input frame to generate a content-rotated frame having a rotated 360-degree content represented in the ERP format, wherein the content-rotated frame comprises a first partial content-rotated frame arranged in the top part of the ERP format, a second partial content-rotated frame arranged in the middle part of the ERP format, and a third partial content-rotated frame arranged in the bottom part of the ERP format, the first partial content-rotated frame includes pixels derived from the first image region, and the third partial content-rotated frame includes pixels derived from the second image region; and
encoding, by a video encoder, the content-rotated frame to generate a part of a bitstream.

10. The video processing method of claim 9, wherein obtaining the motion amount of the selected image region pair comprises:
obtaining a plurality of motion amounts of a plurality of different image region pairs, respectively, wherein each of the different image region pairs has one image region and another image region in the input frame, said one image region corresponds to one area on the sphere, the said another image region corresponds to another area on the sphere, said one area and said another area include points on a same central axis which passes through the center of the sphere; and
comparing the motion amounts of the different image region pairs, and selecting an image region pair with a minimum motion amount from the different image region pairs to act as the selected image region pair.

11. The video processing method of claim 9, further comprising:
comparing the motion amount of the first partial input frame and the third partial input frame with a first predetermined threshold value;
comparing the motion amount of the selected image region pair with a second predetermined threshold value; and
checking if the motion amount of the first partial input frame and the third partial input frame is larger than the first predetermined threshold value;
checking if the motion amount of the selected image region pair is smaller than the second predetermined threshold value; and
applying the content-oriented rotation to the 360-degree content in the input frame to generate the content-rotated frame comprises:
when checking results indicate that the motion amount of the first partial input frame and the third partial input frame is larger than the first predetermined threshold value and the motion amount of the selected image region pair is smaller than the second predetermined threshold value, applying the content-oriented rotation to the 360-degree content in the input frame.

12. A video processing apparatus comprising:
a content-oriented rotation circuit, arranged to:
receive a first input frame having a first 360-degree content represented in a 360-degree Virtual Reality (360 VR) projection format;
apply first content-oriented rotation to the first 360-degree content in the first input frame to generate a first content-rotated frame having a first rotated 360-degree content represented in the 360 VR projection format;
receive a second input frame having a second 360-degree content represented in the 360 VR projection format;
apply second content-oriented rotation to the 360-degree content in the second input frame to generate a second content-rotated frame having a second rotated 360-degree content represented in the 360 VR projection format, wherein the second content-oriented rotation is different from the first content-oriented rotation;
configure content re-rotation according to the first content-oriented rotation and the second content-oriented rotation; and
apply the content re-rotation to a 360-degree content in a reference frame that is derived from a first reconstructed frame to generate a re-rotated reference frame having a re-rotated 360-degree content represented in the 360 VR projection format; and
a video encoder, arranged to:
encode the first content-rotated frame to generate a first part of a bitstream, comprising:
generating the first reconstructed frame of the first content-rotated frame; and
storing the reference frame that is derived from the first reconstructed frame; and
encode the second content-rotated frame to generate a second part of the bitstream, comprising:
using the re-rotated reference frame for predictive coding of the second content-rotated frame.

13. The video processing apparatus of claim 12, wherein the content re-rotation is set by R₁R₀⁻¹, where R₀ represents the first content-oriented rotation, R₁ represents the second content-oriented rotation, and R₀⁻¹ represents derotation of the first content-oriented rotation.

14. The video processing apparatus of claim 12, wherein the reference frame and the re-rotated reference frame co-exist in a same reference frame buffer of the video encoder; or
wherein after the reference frame is stored in a reference frame buffer of the video encoder, the reference frame stored in the reference frame buffer is replaced with the re-rotated reference frame.

15. A video processing apparatus comprising:
a video decoder, arranged to:
receive a bitstream;
process the bitstream to obtain syntax elements from the bitstream, wherein rotation information of a first content-oriented rotation associated with a first decoded frame and a second content-oriented rotation associated with a second decoded frame is indicated by the syntax elements, and the first content-oriented rotation is different from the second content-oriented rotation;
decode a first part of the bitstream to generate the first decoded frame, comprising:
storing a reference frame that is derived from the first decoded frame, wherein the first decoded frame has a first rotated 360-degree content represented in a 360-degree Virtual Reality (360 VR) projection format, and the first content-oriented rotation is involved in generating the first rotated 360-degree content at an encoder side;
decode a second part of the bitstream to generate the second decoded frame, comprising:
using a re-rotated reference frame for predictive decoding involved in generating the second decoded frame, wherein the second decoded frame has a second rotated 360-degree content represented in the 360 VR projection format, and the second content-oriented rotation is involved in generating the second rotated 360-degree content at the encoder side; and
a content-oriented rotation circuit, arranged to:
configure content re-rotation according to the first content-oriented rotation and the second content-oriented rotation; and
apply the content re-rotation to a 360-degree content in the reference frame that is derived from the first decoded frame to generate the re-rotated reference frame having a re-rotated 360-degree content represented in the 360 VR projection format.

16. The video processing apparatus of claim 15, wherein the content re-rotation is set by R₁R₀⁻¹, where R₀ represents the first content-oriented rotation, R₁ represents the second content-oriented rotation, and R₀⁻¹ represents derotation of the first content-oriented rotation.

17. The video processing apparatus of claim 15, wherein the reference frame and the re-rotated reference frame co-exist in a same reference frame buffer of the video decoder; or
wherein after the reference frame is stored into a reference frame buffer of the video decoder, the reference frame stored in the reference frame buffer is replaced with the re-rotated reference frame.

18. A video processing apparatus comprising:
a content-oriented rotation circuit, arranged to:
receive an input frame having a 360-degree content represented in an equirectangular projection (ERP) format, wherein the input frame is obtained from an omnidirectional content of a sphere via equirectangular projection, the input frame comprises a first partial input frame arranged in a top part of the ERP format, a second partial input frame arranged in a middle part of the ERP format, and a third partial input frame arranged in a bottom part of the ERP format, the first partial input frame corresponds to a north polar region of the sphere, the third partial input frame corresponds to a south polar region of the sphere, and the second partial input frame corresponds to a non-polar region between the north polar region and the south polar region;
obtain a motion amount of the first partial input frame and the third partial input frame;
obtain a motion amount of a selected image region pair of a first image region and a second image region in the input frame, wherein the first image region corresponds to a first area on the sphere, the second image region corresponds to a second area on the sphere, and the first area and the second area include points on a same central axis which passes through a center of the sphere;
configure content-oriented rotation according to the motion amount of the first partial input frame and the third partial input frame and the motion amount of the selected image region pair; and
apply the content-oriented rotation to the 360-degree content in the input frame to generate a content-rotated frame having a rotated 360-degree content represented in the ERP format, wherein the content-rotated frame comprises a first partial content-rotated frame arranged in the top part of the ERP format, a second partial content-rotated frame arranged in the middle part of the ERP format, and a third partial content-rotated frame arranged in the bottom part of the ERP format, the first partial content-rotated frame includes pixels derived from the first image region, and the third partial content-rotated frame includes pixels derived from the second image region; and
a video encoder, arranged to encode the content-rotated frame to generate a part of a bitstream.

19. The video processing apparatus of claim 18, wherein the content-oriented rotation circuit obtains a plurality of motion amounts of a plurality of different image region pairs, respectively, where each of the different image region pairs has one image region and another image region in the input frame, said one image region corresponds to one area on the sphere, the said another image region corresponds to another area on the sphere, said one area and said another area include points on a same central axis which passes through the center of the sphere; and the content-oriented rotation circuit compares the motion amounts of the different image region pairs, and selects an image region pair with a minimum motion amount from the different image region pairs to act as the selected image region pair.

20. The video processing apparatus of claim 18, wherein the content-oriented rotation circuit is further arranged to:
compare the motion amount of the first partial input frame and the third partial input frame with a first predetermined threshold value;
compare the motion amount of the selected image region pair with a second predetermined threshold value;
check if the motion amount of the first partial input frame and the third partial input frame is larger than the first predetermined threshold value; and
check if the motion amount of the selected image region pair is smaller than the second predetermined threshold value; and
when checking results indicate that the motion amount of the first partial input frame and the third partial input frame is larger than the first predetermined threshold value and the motion amount of the selected image region pair is smaller than the second predetermined threshold value, the content-oriented rotation circuit applies the content-oriented rotation to the 360-degree content in the input frame.
